(19) United States
(12) Patent Application Publication
(10) Pub. No.: US 2007/0267598 A1
(43) Pub. Date: Nov. 22, 2007

(54) NON-SILICA CONTAINING IMPRESSION AND CASTING MATERIALS

(75) Inventor: Donald W. Renn, Rockport, ME (US)

Correspondence Address: WALTER J, TENCZA JR., 10 STATION PLACE, SUITE 3, METUCHEN, NJ, 08840, US

(73) Assignee: ARTMOLDS, INC., Summit, NJ (US)

(21) Appl. No.: 11/308,885

(22) Filed: May 22, 2006

(51) Int. Cl. C09K 3/00

(52) U.S. Cl. 252/183.11

(57) ABSTRACT

A chemical composition for use in preparing health related impressions, such as dental, medical, and prosthetic impressions is provided. The chemical composition may include a water-soluble alginate, an alginate insolubilizing cation-containing salt, a cation-release moderating component, and a cellulosic filler.

### FIELD OF THE INVENTION

This invention relates to chemical compositions used for making health related impressions such as dental, medical, and prosthetic impressions and life casting.

### BACKGROUND OF THE INVENTION

Silica-containing fillers, such as Celite (trademarked), Perlite (trademarked), kieselguhr, and talc, among others, have been used as fillers to strengthen calcium alginate gels used for dental, medical, and prosthetic impressions and life casting. Magnesium carbonate and calcium carbonate, which are non-silica containing fillers, have been used to strengthen calcium alginate gels. However, the consistency of final gelled products using magnesium carbonate and calcium carbonate is not entirely satisfactory.

Alginate impression materials are well known in the art and are used in dentistry, medicine, prosthetic making, taxidermy, and special effects. In all these fields the materials are used to take impressions of body parts, such as teeth and limbs. In addition, alginates are particularly useful in medical procedures. Specifically, impressions are taken after a surgical procedure is performed and the surgical injuries have healed.

Commonly used impression materials consist of a dry mixture of a water-soluble alginate salt; a moderately soluble salt containing an alginate-gelling cation, such as calcium sulfate; a moderating agent to slow down the reaction of the calcium ion with the alginate, such as tetrasodium pyrophosphate: fillers, such as Celite(trademarked), Perlite(trademarked), kieselguhr, and talc, among others; and optional components, such as humectants, dispersing aids, colorants, pH control agents, etc.

In preparing the alginate impression powder for application, vigorous mixing with water is required. Vigorous mixing often leads to airborne dust. Since the fillers in most impression compositions contain free silica, which has been determined to be a health hazard after repeated exposure, inhalation of the silica can occur. Prolonged inhalation of a high concentration of dust containing free silica can cause the disease known as silicosis. This disease is serious and may lead to a permanent incapacity for work in the affected person. It may also be associated with an increased danger of contracting tuberculosis, or aggravating tuberculosis already present. In addition, inhaled silica may be an inducer or promoter of lung cancer.

### SUMMARY OF THE INVENTION

The present invention in one or more embodiments uses powdered cellulosics and other finely ground fibrous particulated water-insoluble coagulated gelling polysaccharide fibers and combinations of these with powdered cellulose, as fillers to strengthen calcium alginate gels used for dental, medical, and prosthetic impressions, and for life casting. Although magnesium carbonate and calcium carbonate, which are non-silica containing fillers, have been used in the prior art to strengthen calcium alginate gels, the consistency of final gelled products is unexpectedly improved by using cellulosics as fillers in accordance with one or more embodiments of the present invention.

One embodiment of the present invention provides a chemical composition comprised of

a water-soluble alginate, an alginate insolubilizing cation-containing salt, a cation-release moderating component, and a cellulosic filler.

The alginate insolubilizing cation-containing salt may be at least one of a group comprised of sodium, potassium, or ammonium. The chemical composition has a total weight. The alginate insolubilizing cation-containing salt may weigh between six and fifty percent of the total weight of the chemical composition.

The alginate insolubilizing cation-containing salt may be calcium sulfate. The alginate insolubilizing cation-containing salt may weigh between five and twenty-five percent of the total weight of the chemical composition.

The cation-release moderating component may be tetrasodium pyrophosphate. The cation-release moderating component may weigh between five tenths of a percent and five percent of the total weight of the chemical composition. The cellulosic filler may weigh between twenty-five and eighty percent of the total weight of the chemical composition.

The chemical composition may further include one or more of the following optional components: a dispersing aid, a detergent, a humectant, a colorant, or a flavoring agent.

One embodiment of the present invention provides a method comprising using a chemical composition to prepare health related impressions. The chemical composition may be comprised of the one or more components previously specified above. The health related impressions may be dental, medical, or prosthetic impressions.

The impression materials can contain optional components that impart desirable properties to the impression and casting formulations. These optional components include humectants, such as glycerin, polyethylene glycols, propylene glycols, sorbitol, mannitol, etc.; dispersion aids, such as maltodextrin and lecithins: detergents such as the Tweens(trademarked), Tergitols(trademarked), sodium dodecyl ammonium sulfate (SDS), etc.; other water soluble components, such as sugars, colorants and flavoring agents; and water insoluble materials, and particulates, such as flours and starches.

### BRIEF DESCRIPTION OF THE DRAWINGS

FIG. 1 shows a flow chart of a method in accordance with an embodiment of the present invention.

### DETAILED DESCRIPTION OF THE DRAWINGS

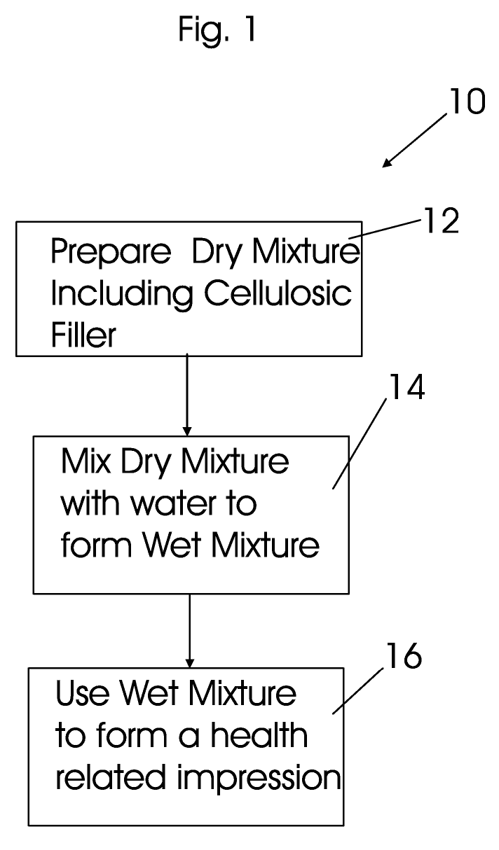

FIG. 1 shows a flow chart 10 of a method in accordance with an embodiment of the present invention. At step 12 of the method, a dry mixture including a cellulosic filler is prepared. The dry mixture may be comprised of a water-soluble alginate, a moderately soluble alginate insolubilizing cation-containing salt, a cation-release moderating component, and a cellulosic filler.

The alginate insolubilizing cation-containing salt may be at least one of a group comprised of sodium, potassium, or ammonium. The chemical composition has a total weight. The alginate insolubilizing cation-containing salt may weigh between six and fifty percent of the total weight of the chemical composition.

The alginate insolubilizing cation-containing salt may be calcium sulfate. The alginate insolubilizing cation-containing salt may weigh between five and twenty-five percent of the total weight of the chemical composition.

The cation-release moderating component may be tetrasodium pyrophosphate. The chemical composition may have a total weight. The cation-release moderating component may weigh between five tenths of a percent and five percent of the total weight of the chemical composition. The cellulosic filler may weigh between twenty-five and eighty percent of the total weight of the chemical composition.

The chemical composition may further include one or more of the following optional components: a dispersing aid, a detergent, a humectant, a colorant, or a flavoring agent.

At step 14 of the method of FIG. 1, the dry mixture is mixed with water to form a wet mixture. Vigorous mixing of the dry mixture with water is typically required. At step 16, the wet mixture can be used to form a health related impression, such as a medical, dental, or prosthetic impression. The alginate in the wet mixture gels into an impression mold in a time that varies from about two to ten minutes, depending upon the concentration of the moderating agent.

One embodiment of the present invention provides a method comprising using a chemical composition to prepare health related impressions. The chemical composition may be comprised of the one or more components previously specified above. The health related impressions may be dental, medical, or prosthetic impressions.

The cellulosic filler is typically a powdered cellulosic and can be obtained from a variety of sources, such as wood pulp, plant fibers, recycled paper, etc. The following are several examples of a dry mixture, which can be used in one or more embodiments of the present invention. The list is not meant to be exclusionary, but represents a few of the possibilities:

(1) First Example of a Dry Mixture

A dry, thoroughly blended mixture comprised of:
12 grams of prime alginate F200 (Multi-Kem Corporation)(trademarked) (a water-soluble alginate);
1.5 grams of tetrasodium pyrophosphate (a moderating alginate insolubilizing salt);
9 grams of calcium sulfate (a cation-release alginate-insolubilizing component);
4 grams of magnesium oxide (heavy) (an optional component for pH moderating);
2 grams potassium hexafluoro titanate (an optional component for pH moderating); and
72.5 grams of SolkaFloc(trademarked) (International Fiber Corporation) (a cellulosic filler).

For testing smoothness and set time, 16.5 grams of the first example of a dry mixture and 70 grams of 80° Fahrenheit water were stirred vigorously for one minute. The resulting wet mixture was white and creamy and had a set time of 3:05 minutes.

(2) Second Example of a Dry Mixture

A dry, thoroughly blended mixture comprised of:
14 grams of Prime alginate F200 (Multi-Kem Corporation)(a water-soluble alginate);
14 grams of calcium sulfate (a cation-release alginate-insolubilizing component);
2.2 grams of TSPP (tetrasodium pyrophosphate)(a cation-release moderating component);
14 grams of Maltrin M040 (Grain Processing Corporation)(trademarked)(an optional alginate dispersing aid); and
55.8 grams of CreaTech TC 40 (trademarked) (a powdered cellulosic filler) (Creafill Corporation)(trademarked).

For testing smoothness and set time, 10 grams of the second example of a dry mixture and 50 grams of 80° Fahrenheit distilled water were stirred vigorously for one minute. The resulting mixture was smooth with a few small particles and had a set time of 3:03 minutes.

(3) Third Example of a Dry Mixture

A dry, thoroughly blended mixture comprised of:

14 grams of Prime alginate F200 (Multi-Kem Corporation)(a water-soluble alginate);
12 grams of calcium sulfate (a cation-release alginate-insolubilizing component);
2 grams of TSPP (tetrasodium pyrophosphate) (a cation-release moderating component);
22 grams Maltrin M040 (Grain Processing Corporation) (an optional alginate dispersing aid); and
50 grams of CreaTech TC 90 (trademarked) powdered cellulose (Creafill Fibers) (Trademarked) (a powdered cellulosic filler).

For testing smoothness and set time, 15 grams of the third example of a dry mixture and 75 milliliters of 80° Fahrenheit distilled water were stirred vigorously for one minute. The resulting wet mixture was very smooth and had a set time of 2:50 minutes.

(4) Fourth Example of a Dry Mixture

A dry, thoroughly blended mixture comprised of:
14 grams of Prime alginate F200 (Multi-Kem Corporation)(a water-soluble alginate);
12 grams of calcium sulfate(a cation-release alginate-insolubilizing component);
2 grams of TSPP (tetrasodium pyrophosphate)(a cation-release moderating component);
22 grams of Maltrin M040 (Grain Processing Corporation) (an optional alginate dispersing aid); and
50 grams of CreaTech TC 200 powdered cellulose (Creafill Fibers)(a powdered cellulosic filler).

For testing smoothness and set time, 15 grams of the fourth example of a dry mixture and 75 milliliters of 80° Fahrenheit distilled water were stirred vigorously for one minute. The resulting wet mixture was rather thick, but smooth and had a set time of 2:13 minutes.

The fourth example of a dry mixture can be prepared using a KitchenAid Mixer (trademarked).

(5) Fifth Example of a Dry Mixture

A dry, thoroughly blended mixture comprised of:
14 grams of Prime alginate F200 (Multi-Kem Corporation)(a water-soluble alginate);
12 grams of calcium sulfate(a cation-release alginate-insolubilizing component);
2 grams of TSPP (tetrasodium pyrophosphate)(a cation-release moderating component);
22 grams of Maltrin M040 (Grain Processing Corporation) (an optional alginate dispersing aid); and
and 50 g AVICEL(trademarked ) microcrystalline cellulose PH-105 (FMC Corporation) (a powdered cellulosic filler).

For testing smoothness and set time, 15 grams of the fifth example of a dry mixture and 75 milliliter of 8020 Fahrenheit distilled water were stirred vigorously for one minute. The resulting wet mixture was smooth with a few small lumps and had a set time of 5:12 minutes.

(6) Sixth Example of a Dry Mixture

A dry, thoroughly blended mixture comprised of:
11 grams of Prime alginate F200 (Multi-Kem Corporation) (a water-soluble alginate);
6 grams of calcium sulfate (a cation release alginate-insolubilizing component);
0.5 grams of TSPP (tetrasodium pyrophosphate)(a cation-release moderating component); and
9 grams of Citri-Fi (trademarked) 100 (a powdered cellulosic filler) (Fiberstar) (trademarked).

For testing smoothness and set time, 15 grams of the dry mixture and 75 milliliter (ml) of 80° Fahrenheit distilled water were stirred vigorously for one minute. The resulting wet mixture was somewhat lumpy and had a set time of 5:15 minutes.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. A chemical composition comprised of
a water-soluble alginate;
an alginate insolubilizing cation-containing salt;
a cation-release moderating component;
and a cellulosic filler.

2. The chemical composition of claim 1 wherein
the alginate insolubilizing cation-containing salt is at least one of a group comprised of sodium, potassium, or ammonium.

3. The chemical composition of claim 2 wherein
the chemical composition has a total weight; and
wherein the alginate insolubilizing cation-containing salt weighs between six and fifty percent of the total weight of the chemical composition.

4. The chemical composition of claim 1 wherein
the alginate insolubilizing cation-containing salt is calcium sulfate.

5. The chemical composition of claim 4 wherein
the chemical composition has a total weight; and
wherein the alginate insolubilizing cation-containing salt weighs between five and twenty-five percent of the total weight of the chemical composition.

6. The chemical composition of claim 1 wherein
the cation-release moderating component is tetrasodium pyrophosphate.

7. The chemical composition of claim 6 wherein
the chemical composition has a total weight; and
the cation-release moderating component weighs between five tenths of a percent and five percent of the total weight of the chemical composition.

8. The chemical composition of claim 1 wherein
the chemical composition has a total weight; and
wherein the cellulosic filler weighs between twenty-five and eighty percent of the total weight of the chemical composition.

9. The chemical composition of claim 1 further comprising
a dispersing aid.

10. The chemical composition of claim 1 further comprising
a detergent.

11. The chemical composition of claim 1 further comprising
a humectant.

12. The chemical composition of claim 1 further comprising
a colorant.

13. The chemical composition of claim 1 further comprising
a flavoring agent.

14. A method comprising
using a chemical composition to prepare health related impressions;
wherein the chemical composition is comprised of:
a water-soluble alginate;
an alginate insolubilizing cation-containing salt;
a cation-release moderating component;
and a cellulosic filler.

15. The method of claim 14 wherein
the health related impressions are dental impressions.

16. The method of claim 14 wherein
the health related impressions are medical impressions.

17. The method of claim 14 wherein
the health related impressions are prosthetic impressions.

18. The method of claim 14 wherein
the alginate insolubilizing cation-containing salt is at least one of a group comprised of sodium, potassium, or ammonium.

19. The method of claim 14 wherein
the alginate insolubilizing cation-containing salt is calcium sulfate.

20. The method of claim 14 wherein
the cation-release moderating component is tetrasodium pyrophosphate.
